(19) United States
(12) Patent Application Publication
(10) Pub. No.: US 2023/0322536 A1
(43) Pub. Date: Oct. 12, 2023

(54) SYSTEM AND METHOD OF PROVIDING A ROBOTIC OMNIDIRECTIONAL REACHTRUCK

(71) Applicant: Vecna Robotics, Inc., Waltham, MA (US)

(72) Inventors: Daniel Theobald, Waltham, MA (US); Michael Baier, Waltham, MA (US); Siddharth Chhatpar, Winchester, MA (US)

(21) Appl. No.: 18/127,563

(22) Filed: Mar. 28, 2023

Related U.S. Application Data
(60) Provisional application No. 63/324,293, filed on Mar. 28, 2022.

(51) Int. Cl. B66F 9/06; B66F 9/075; G05D 1/00; B66F 9/07

(52) U.S. Cl. CPC B66F 9/063; B66F 9/07; B66F 9/07559; G05D 1/0088; G05D 2201/0216

(57) ABSTRACT

An example system includes an omnidirectional robot reachtruck or system that has a set of steerable wheels configures in a U-shaped base structure, a vertical track structure that enables an engagement structure or extendible forklift to be raised and lowered, and a housing that stores control components, engine and energy components. Each of the wheels is steerable thus making the robot omnidirectional. The U-shaped base structure enables the system to lower the engagement structure or forklift to the ground and to pick up pallets or other items that fit between the projections of the U-shaped base structure.

### PRIORITY INFORMATION

The present application claims priority to U.S. Provisional Application No. 63/324,293, filed Mar. 28, 2022, the contents of which is incorporated herein by reference in its entirety.

### FIELD OF THE INVENTION

The present technology pertains to robotics and more specifically to a system and method of providing a robotic omnidirectional reachtruck or robotic system that moves in any direction and includes a forklift structure or other engagement structure for lifting items.

### BACKGROUND

Currently, in warehouses there are some robotic operations to move items from one place to another. However, these robots are often small and basically picking robots having baskets that receive items. Forklifts are known to be manually operated to move large items or pallets of items. However, forklifts often are configured with a structure that makes it difficult to move in narrow isles in a warehouse.

### SUMMARY

What is needed in the art is an improved robot that can lift heavier items such as pallets of goods. Further, a new robotic structure that can enable the robot to move in narrow isles between storage shelving in warehouses is desirable.

Disclosed herein is an omnidirectional robot reachtruck that has four steerable wheels configures in a U-shaped base structure, a vertical track structure that enables an extendible forklift to be raised and lowered, and a housing that stores control components, engine and energy components. Each of the wheels is steerable thus making the robot omnidirectional. The U-shaped base structure enables the system to lower the forklift to the ground and to pick up pallets or other items that fit between the projections of the U-shaped base structure.

A method embodiment can include: storing in a non-transitory computer-readable memory a planned path for a robotic system. The robotic system can include: a case; a U-shaped base structure connected to the case; a set of wheels configured in the U-shaped base structure, each wheel of the set of wheels being steerable; an elevated structure attached to the U-shaped base structure and having a track; an extension structure configured at least in part with the track on the elevated structure; an engagement structure configured with the elevated structure; and a control system configured to control a motor to control operation of the set of wheels and the extension structure. The robotic system is omnidirectional and enables the extension structure to move up and down the track and retrieve or drop off items at various levels using the engagement structure. The method can include retrieving, as managed by the control system, an item via the engagement structure, moving the robotic system according to its planned path to a destination and dropping off, as managed by the control system, the item at the destination.

Other embodiments can include a system including means for storing in a non-transitory computer-readable memory a planned path for a robotic system. The robotic system can include one or more of a case; a U-shaped base structure connected to the case; a set of wheels configured in the U-shaped base structure, each wheel of the set of wheels being steerable; an elevated structure attached to the U-shaped base structure and having a track; an extension structure configured at least in part with the track on the elevated structure; an engagement structure configured with the elevated structure; and a control system configured to control a motor to control operation of the set of wheels and the extension structure. The robotic system can be omnidirectional and enable the extension structure to move up and down the track and retrieve or drop off items at various levels using the engagement structure. The system can include means for retrieving, as managed by the control system, an item via the engagement structure, means for moving the robotic system according to its planned path to a destination and means for dropping off, as managed by the control system, the item at the destination.

In another embodiment, a system includes one or more of a base structure; a set of wheels configured in the base structure, each wheel of the set of wheels being steerable and each wheel configured in a respective corner of the base structure; an elevated structure attached to the base structure and having a track; an extension structure configured at least in part with the track on the elevated structure; an engagement structure configured with the extension structure, wherein the engagement structure can be extended beyond an edge of the base structure for retrieving or dropping off items; and a control system configured to control a motor to control operation of the set of wheels and the extension structure. The system is omnidirectional and enables the extension structure to move up and down the track and retrieve or drop off items at various levels using the engagement structure.

The various embodiments disclosed herein can include methods, systems, drones, vehicles, robotic retrieval systems, storage spaces for vehicles, charging stations for drones, battery replacement structures, control systems on one or more of the vehicle, a central server configuration, or a distributed approach, and so forth. This disclosure provides a new ecosystem for vehicles to be used to deliver packages in a more efficient manner and any single component (a robot, a drone, a vehicle, a control system, etc.) can be separately considered an embodiment.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIGS. 1A-B illustrate various views of a robotic omnidirectional reachtruck;

FIGS. 2A-E illustrate various perspective views of the robotic omnidirectional reachtruck;

FIGS. 3A-D illustrate various perspective views of the robotic omnidirectional reachtruck from a floor level position;

FIG. 4A illustrates a top view of the robotic omnidirectional reachtruck;

FIG. 4B illustrates a bottom view of the robotic omnidirectional reachtruck;

FIG. 5 illustrates a method embodiment of using a robotic system; and

FIG. 6 illustrates a system according to some aspects of this disclosure.

### DESCRIPTION OF EXAMPLE EMBODIMENTS

Various example embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the example embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative example embodiments mutually exclusive of other example embodiments. Moreover, various features are described which may be exhibited by some example embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various example embodiments given in this specification.

Without intent to limit the scope of the disclosure, examples of instruments, apparatus, methods and their related results according to the example embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

For clarity of explanation, in some instances the present technology may be presented as including individual functional blocks including functional blocks comprising devices, device components, steps or routines in a method embodied in software, or combinations of hardware and software.

The following discussion introduces a new vehicle with a number of different structures and configurations which can be used to improve the efficiency and safety of moving pallets and other items via a new robotic structure or system. Any individual component can be combined with any one or more other disclosed component to arrive at the system disclosed herein.

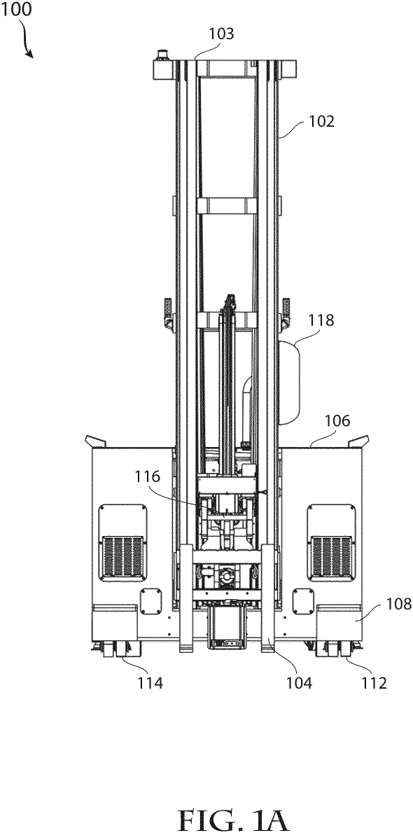

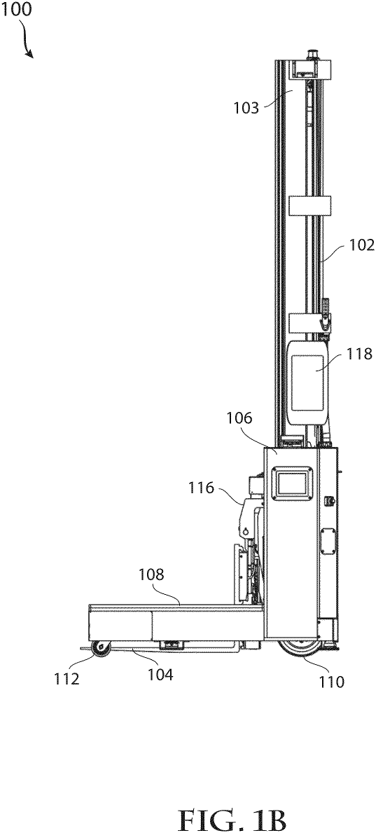

FIGS. 1A-B illustrate various views of a system, or robotic system or a robotic omnidirectional reachtruck 100. The robotic omnidirectional reachtruck 100 can also be called generally a system having a control mechanism 118 and other components such as a case 106 for housing equipment, an elevated structure or mast 102 that is configured with a track 103 which enables an extension structure 116 to move up and down the track 103 as controlled by the control mechanism 118. The case 106 can be connected to the base structure. The track(s) 103 can be configured vertically such that the extension structure 116 (which attaches to the engagement mechanism or forklift 104) can move up and down vertically. In one aspect, the extension structure 116 can be a double deep pantograph mechanism, meaning that it enables an engagement member or forklift 104 to reach deep into a shelf to a “double deep” position on the shelf or on a floor level and can have a pantograph mechanical linkage. The extension structure 116 is connected to an engagement member or forklift 104 which is configured to be able to be moved up and down and to engage with a pallet that can contain items. FIG. 1B shows the forklift structure at a lowered position. A U-shaped base structure 108 is shown that includes wheels 110, 112, 114, 120. Each of the wheels is configured to be steerable such that the system 100 can be omnidirectional. The engagement member or forklift 104 can also be changed out for other structures for retrieving or dropping off items. The engagement member or forklift 104 can more generally be characterized as an engagement structure 104 that is used to engage with items. For example, it could be a grabber, a suction cup (or cups), etc.

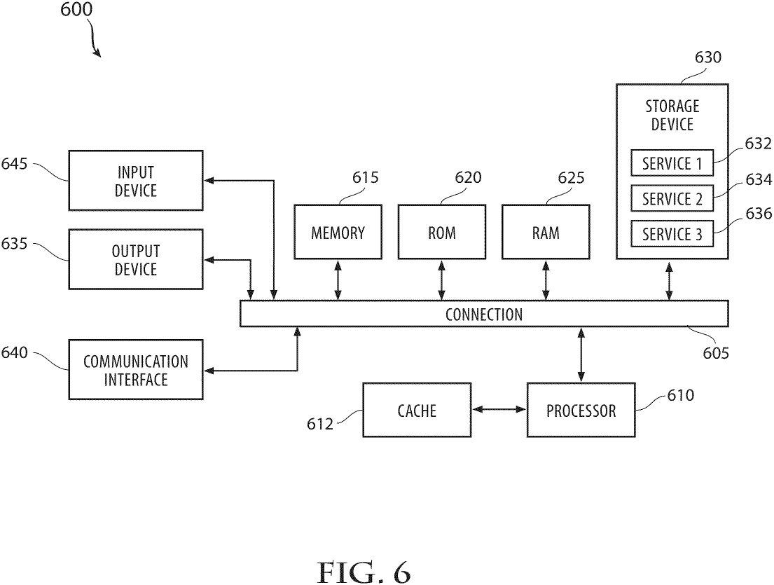

The control mechanism 118 is configured at a particular location on the robotic system 100 but it can be configured anywhere. The control mechanism 118 can also be characterized as a control system or control module and can include computer components as shown in FIG. 6 for storing data and executing instructions to move various mechanical components of the robotic system 100.

In one example, a system 100 can include a case 106, a U-shaped base structure 108 connected to the case 106, a set of wheels 110, 112, 114, 120 configured in the U-shaped base structure 108, each wheel of the set of wheels being steerable. The system 100 can include an elevated structure or mast 102 attached to the U-shaped base structure 108 and having a track 103 or a pair of tracks, an extension structure 116 configured at least in part with the track 103 on the elevated structure 102, an engagement structure 104 configured with the elevated structure 102 and a control system 118 controlling a motor to control operation of the set of wheels and the extension structure 116. The system 100 in one aspect can be omnidirectional and enables the extension structure 106 to move up and down the track 103 and retrieve or drop off items at various levels using the engagement structure 104. The engagement structure 104 can be configured in different ways. Shown in the figures are two extensions similar to a fork on a fork-lift. However, suction cups, a scoop, a platform, a grabber, a robotic hand, or other engagement structures could be used to pick up and drop off items or pallets. In one aspect, the extension structure 116 could enable interchangeable engagement structures 104 which can be tailored to be complementary to specific item configurations that are to be picked up.

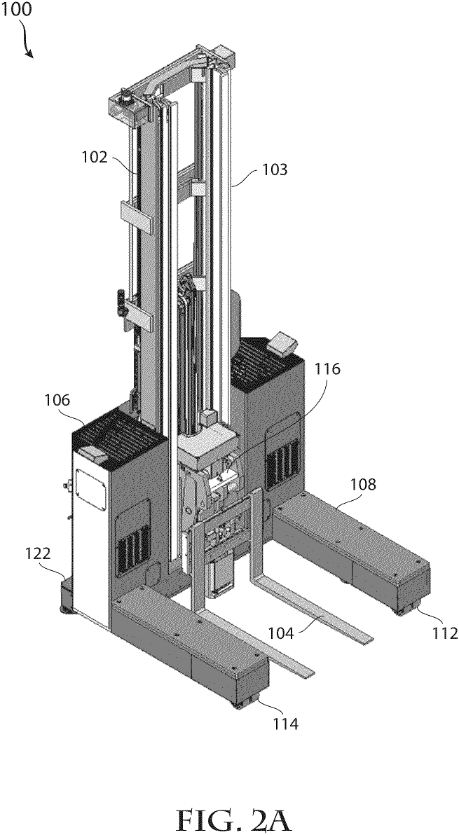

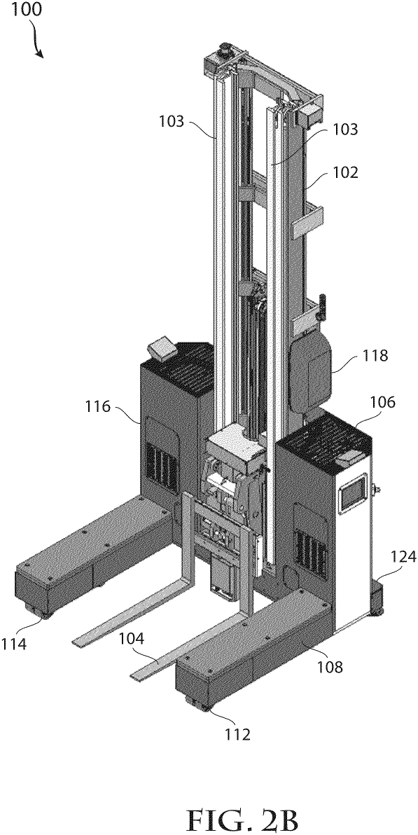

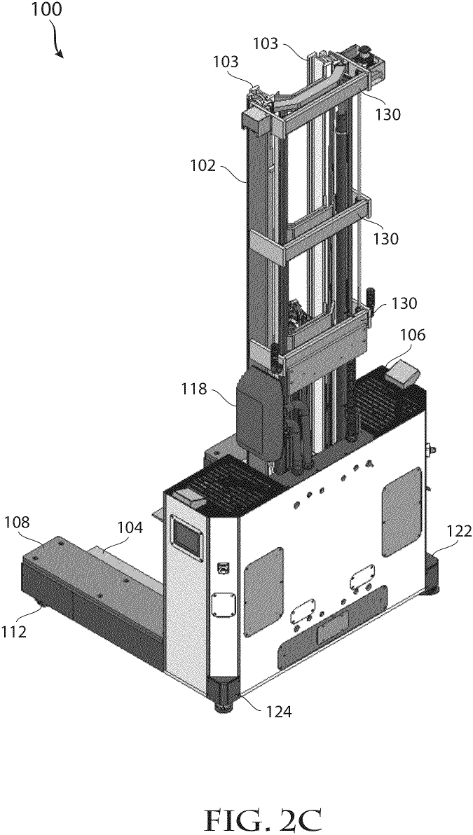

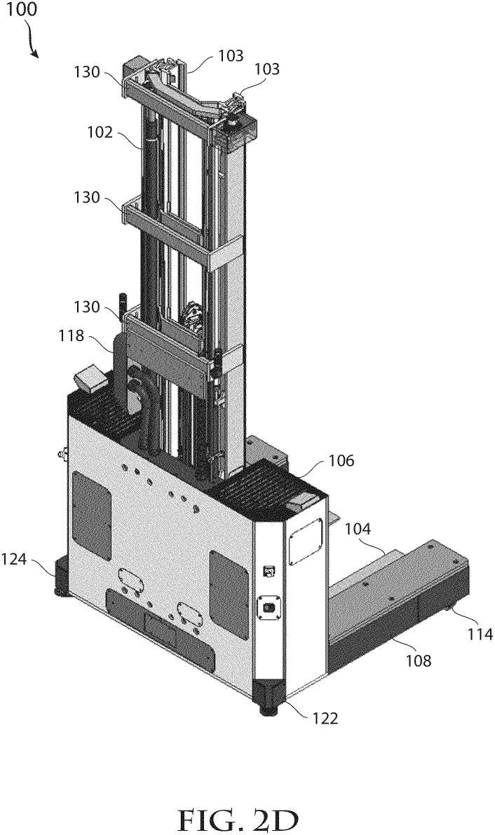

FIGS. 2A-E illustrate various perspective views of the robotic omnidirectional reachtruck 100. These figures show an extendible base support 122, 124 configured at the corners of the case 106 and that can be used if additional stability is needed to lift an item with the engagement structure or example forklift 104. Legs can extend down from each of these base supports 122, 124 to provide a more stable foundation for the system 100 than the wheels alone. Note that each of the wheels 110, 112, 114, 120 can have an engine or a powered configuration as well as a steerable configuration such that the system 100 is omnidirectional. Each of wheels 110, 112, 114, 120 can be individually steered and controlled. FIG. 2E illustrates the system with the extension structure 116 in a midway position up the track 103 and in an extended position. In this manner, the system 100 can be used to retrieve or drop off a pallet on a shelf (not shown). The item may be a pallet or any other item and the configuration of the engagement structure 104 can vary based on the configuration of the item to be moved. The height of shelves (not shown) that can be accessed is only limited by the height of the elevated structure 102 and the track 103 that the extension structure 116 moves up and down. The extension structure 116 and engagement member or forklift 104 can utilize an outrigger mounted ballast for dynamic stability.

In another aspect, the extension structure 116 and example engagement member or forklift 104 can utilize brake-able and steer-able casters or wheels 110, 112, 114, 120. The extension structure 116 and the example engagement member or forklift 104 can utilize an extendable outrigger mounted ballast for dynamic stability. In yet another aspect, the extension structure 116 and the example engagement member or forklift 104 can utilize a single centered outrigger. The system can utilize actuated outriggers for runtime configuration changes allowing for compatibility with multiple rack configurations. One example of such outriggers can include features 122, 124 shown in the figures.

FIG. 2C illustrates three brackets or structures 130 connecting the rails 103 to provide stability. The number of brackets 130 is provided by way of example. Other structures or numbers of structures might be used as well and the number is not limited to three.

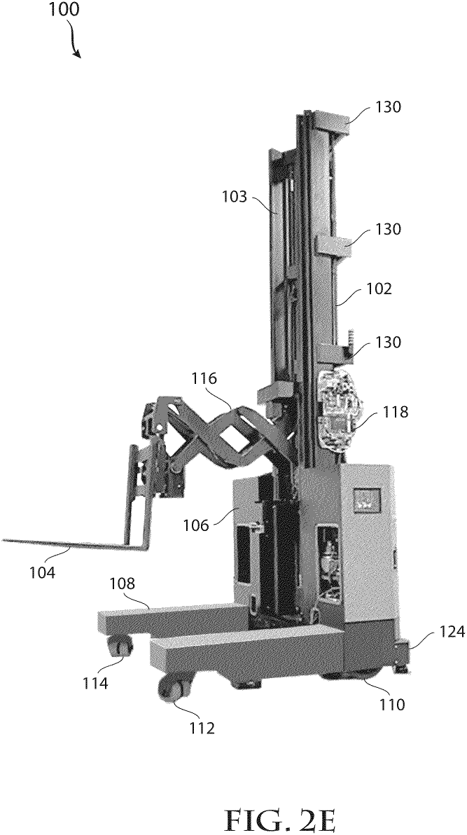

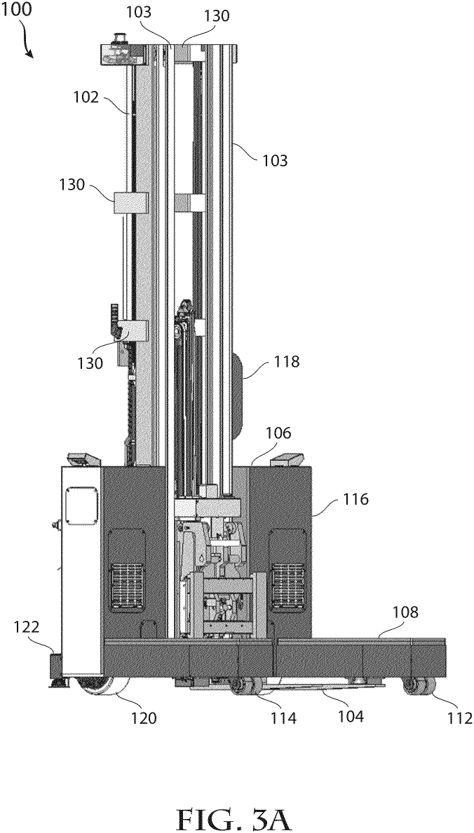

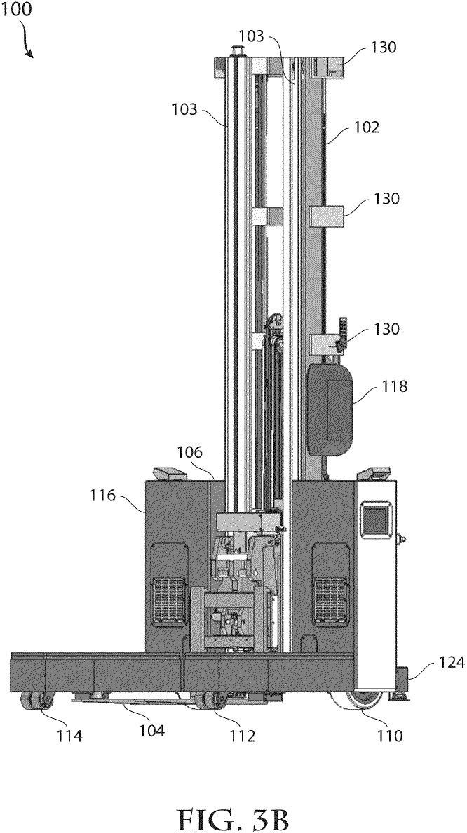

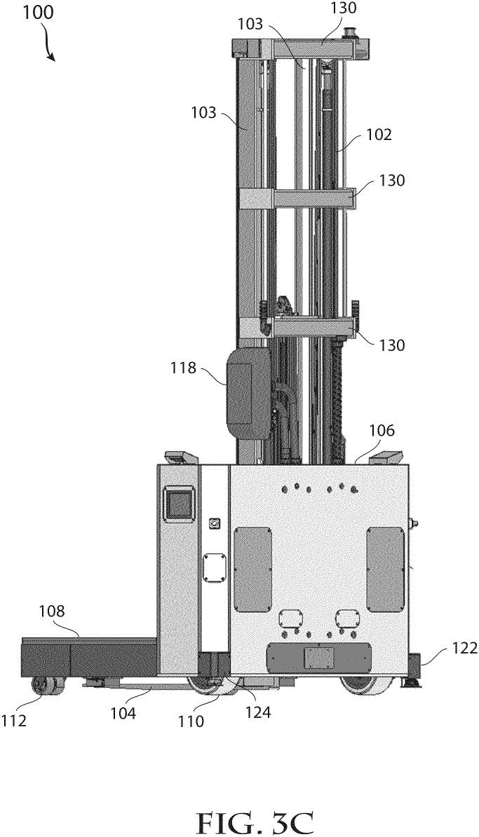

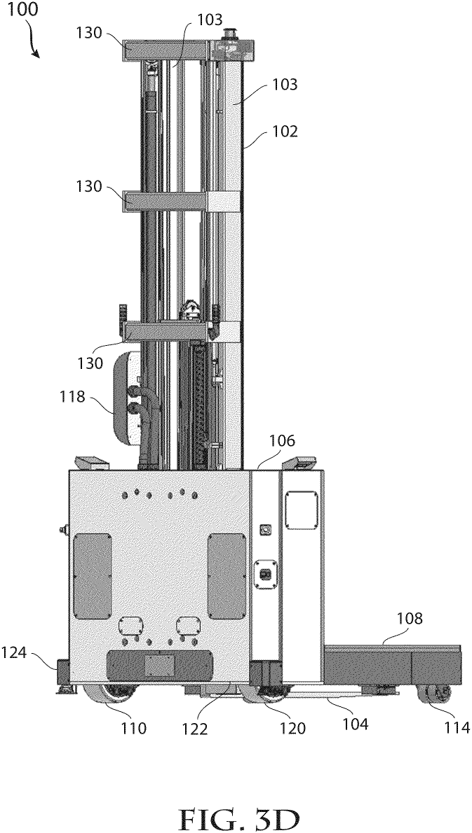

FIGS. 3A-D illustrate various perspective views of the robotic omnidirectional reachtruck 100 from a floor level position. Note that the engagement member or forklift 104 is shown with its configuration to retrieve and deliver pallets but a different structure could also be attached to the extension structure 116. In this manner, the system could be modularized where a different structure such as suction cups or a grabbing mechanism could be attached to the extension structure 116 and then used to retrieve or drop off items.

FIG. 3A shows a front left view of the system 100 and FIG. 3B shows a front right view of the system 100. FIG. 3C shows a rear view of the system 100. The case 106 can house various mechanical and electrical components for operating the system 100 and the forklift 104. FIG. 3D illustrates another rear view of the system 100.

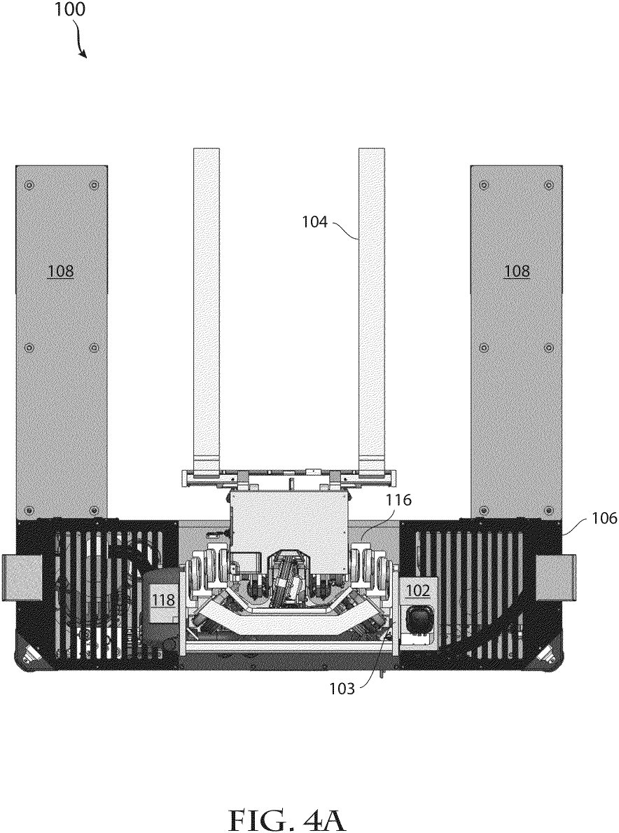

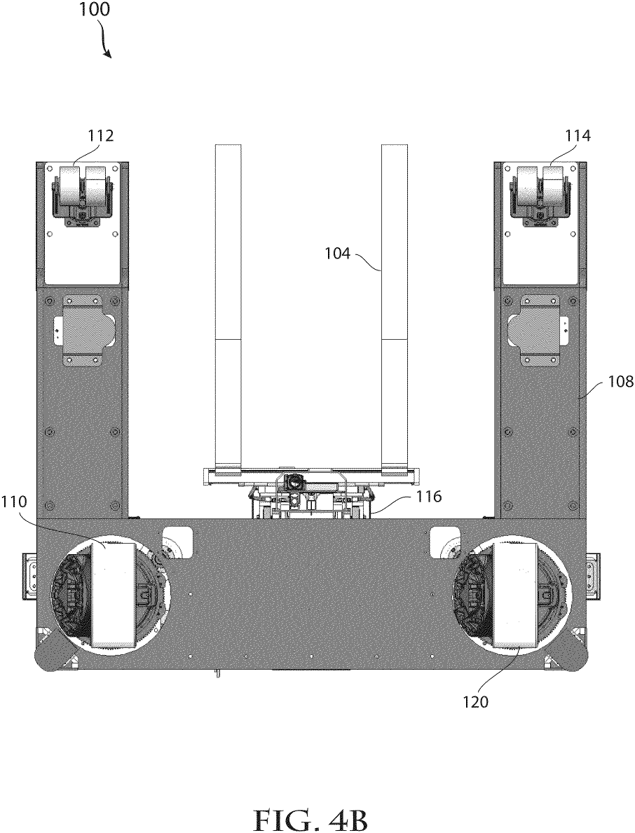

FIG. 4A illustrates a top view of the robotic omnidirectional reachtruck 100 showing the case 106 and vents on a top surface of the case 106 with some of the mechanical components inside the case 106 used for operating the system 100. Further details of the mechanical components that make up the extension structure 116 are shown as well that enable the engagement structure or forklift 104 to be extended at the chosen level to pick up an item from the floor or a shelf and the carry it to a destination location and drop the item off on the floor or a shelf. The mechanical components can include brackets, cabling, telescoping structures, telescopic extension structures, extension and retraction structures, booms, or other example mechanisms for extending and retracting the engagement structure or forklift 104 at the chosen height along the tracks 103. Those of skill in the art would understand various technical approaches to extending and retracting the engagement structure or forklift 104. The extension structure 116 shown by way of example is a scissor extension or a scissor lift operating in a horizontal direction but any other configuration could also be used.

Various components can be incorporated into the robotic omnidirectional reachtruck 100 such as hydraulics, electrical motors, sensors, cameras, batteries, voice synthesis and voice recognition systems, piezo motors, actuators, joint-angle sensors, wireless communication systems such as WiFi and BlueTooth® for example, and so forth to enable the movement of the robotic omnidirectional reachtruck 100 described herein.

FIG. 4B illustrates a bottom view of the robotic omnidirectional reachtruck 100. In this example, wheels 110, 120 are driven or powers to move the system 100 while wheels 112, 114 are not. However, all four wheels are used for steering. This view also illustrates the U-shaped configuration of this base component 108. The wheels 112, 114, 110, 120 are set at the corners or in a corner region as shown and each wheel can be steered independent of the others as controlled by the control system 118. One or more of the wheels can be powered to enable movement of the system 100. In one configuration, wheels 110, 120 are powered and steerable and wheels 112, 114 are only steerable.

The system 100 can also include various sensors which can include motion, visual, cameras, heat, and so forth. Various sensors can be configured in one or more locations of the system 100 and can be in communication with the control system 118 to ensure that the system 100 is safe as it moves around and is aware of the surroundings. Artificial intelligence or machine learning models can be trained to also assist in the safe movement of the system 100 around to pickup and deliver packages. In another aspect, navigation systems can be included in the control system 118 such that radars, or other systems can be used to aid in navigation.

Other features of the system include the following. Picking and placing of items by the system 100 is not limited by sideshift because of the omnidirectional base. Thus, because all four wheels 112, 114, 110, 120 are steerable, more flexibility in positioning the system 100 is possible relative to prior systems. The system 100 allows for pallets not to be positioned precisely for rapid picks and drop offs. Again, this is a feature that is possible because of the omnidirectional nature of the system 100 and can reduce the precision necessary for objects in a warehouse or other setting to be able to be retrieved and dropped off. The system 100 is mobile that allows for double-deep picks as well in which two items are retrieved at the same time. The system 100 can operate in aisles of a warehouse as narrow as eight feet. In this regard, the dimensions of the system 100 in one example can be less than eight feet in either horizontal direction or in both horizontal directions to enable movement in an eight foot aisle. Note FIG. 2E which illustrates the extended state of the extension structure 116. A scissor structure is shown as the extension structure 116 in this example, but other extension mechanisms can be used. A pallet could be deep on a higher shelf and the extension structure 116 can be used to access the double deep pallet in ways not possible in current systems.

The system 100 is safe to operate alongside people as it is automated with a fallback option for manual operation via joystick (not shown). The system 100 can be automated and have instructions stored in a computer-readable device for movement, pickup and delivery. The system 100 can also be remotely controlled by a control system (not shown) which can provide wireless data or instructions. In one example, a wireless communication system can be configured with the system 100 and which can be operated or controlled by an app or website accessible by a mobile device of a user.

The sensos mentioned above can be used to change a path of the system based on real-time sensor feedback. The control system 118 can also include a reroutable ASRS (Automatic Storage and Retrieval System) and in one aspect a fully mobile ASRS. The system 100 can include a passive sensor movement system that allows for viewing different parts of the environment as needed. The system 100 can include an active tip detection and mitigation system. As noted above, a double-deep capable ASRS can be built on an omnidirectional mobile base 108.

The system 100 can include a performance level (PL) D supervisory system for omnidirectional platforms. The PL is a value used to define the ability of safety-related parts of control systems to perform a safety function under foreseeable conditions. Other PL’s besides level D could also be a requirement. The ASRS that can utilize drive-in racking and flow racking as well.

Other features can include a mobile ASRS with a movable mast 102. The mobile ASRS with movable mast can enable the double deep pantograph mechanism 116. In one asecpt, the system 100 can have a raised undercarriage for allowing for unobstructed sensor views beneath the system 100. The system 100 can utilize two powered and steerable drive assemblies for maximum maneuverability. These drive assemblies can be seen in FIG. 4B in connection with wheels 110, 120. A battery (not shown) can be mounted within the casing 106 and be used to power the system. The system 100 can utilize a single sensor for camera feeds as well as 3D object detection & recognition. Machine learning models can be used to receive data from sensors and classify the information as particular objects, people, shelfs, pallets, chairs, and so forth.

The system 100 can be charged while it is on either through a wired connection or through a wireless connection. The system can utilize an automotive charge connector and can allow for charging or charged vehicles to contribute computing power for fleetwide simulations.

One benefit of the omnidirectional structure and the ability to steer each of the wheels is that the system 100 that does not need to turn 90 degrees while traveling through an aisle to preform picks and places from racking. The system 100 can include a primary hydraulic circuit to control the engagement member or forklift 104 and can also utilize a secondary parallel hydraulic circuit for fine fork control. The system 100 can utilize vehicle mounted fiducial markers for auto-charging systems.

The system 100 can use two monitors for increased usability by operators and an ASRS system that is fully remotely tele-operable. The ASRS system can also be infrastructure free to utilize free form navigation. A control system 118 can provide x, y, and theta velocity commands as part of the control mechanics. The system can speed up engagement member or forklift 104 maneuvers by allowing for drive casters 110, 112, 114, 120 to minimize travel distance. The control system 118 can monitor the steer caster positions and automatically halts drive motor commands until wheels are in position allowing for more precise maneuvering.

This disclosure can also include a method of operating the system 100 to move in an omnidirectional fashion, control the extension structure 116 to utilize the engagement structure 104 to pick up or drop of an item at one or more elevations. Any step that is performed by the system 100 from the standpoint of a stand-alone system or a remotely controlled system can be added by way of a method embodiment outlining the steps that are performed.

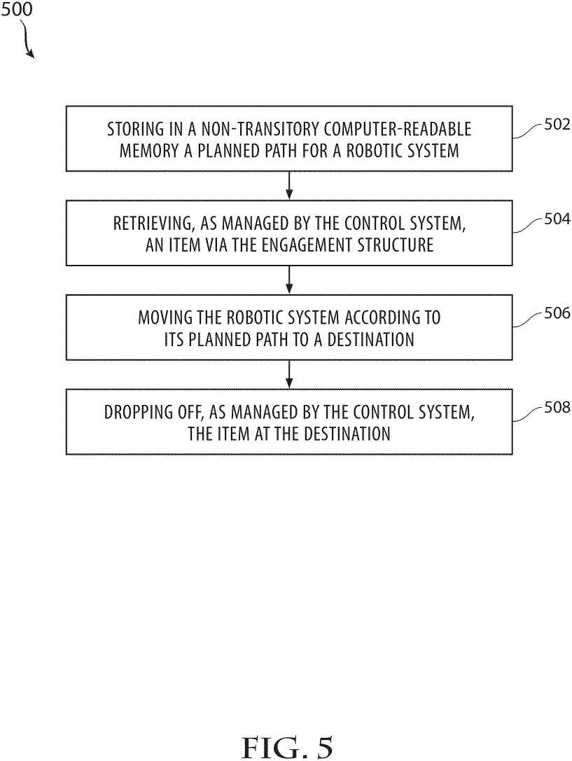

FIG. 5 illustrates an example method embodiment. A method 500 can include storing in a non-transitory computer-readable memory a planned path for a robotic system (502). The robotic system can include any of the systems disclosed herein and can include a memory as shown in FIG. 6 that can store path information. The robotic system may nave stored thereon a path which can include a pick-up location for an item and a destination for the item. The robotic system can include a case, a U-shaped base structure connected to the case, a set of wheels configured in the U-shaped base structure, each wheel of the set of wheels being steerable, an elevated structure attached to the U-shaped base structure and having a track, an extension structure configured at least in part with the track on the elevated structure, an engagement structure configured with the elevated structure and a control system configured to control a motor to control operation of the set of wheels and the extension structure, wherein the robotic system is omnidirectional and enables the extension structure to move up and down the track and retrieve or drop off items at various levels using the engagement structure.

The method 500 can include retrieving, as managed by the control system, an item via the engagement structure (504), moving the robotic system according to its planned path to a destination (506) and dropping off, as managed by the control system, the item at the destination (508). The method may also include adjusting the planned path based on feedback from a sensor on the robotic system.

FIG. 6 illustrates example computer device that can be used in connection with any of the systems disclosed herein. For example, items in the computing device can be part of the control mechanism 118 shown above. In this example, FIG. 6 illustrates a computing system 600 including components in electrical communication with each other using a connection 605, such as a bus. System 600 includes a processing unit (CPU or processor) 610 and a system connection 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware or software service, such as service 1 632, service 2 634, and service 3 636 stored in storage device 630, configured to control the processor 610 as well as a special-purpose processor where software instructions are incorporated into the actual processor design. The processor 610 may be a completely self-contained computing system, containing multiple cores or processors, a bus, memory controller, cache, etc. A multi-core processor may be symmetric or asymmetric.

To enable user interaction with the device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include services 632, 634, 636 for controlling the processor 610. Other hardware or software modules are contemplated. The storage device 630 can be connected to the system connection 605. In one aspect, a hardware module that performs a particular function can include the software component stored in a computer-readable medium in connection with the necessary hardware components, such as the processor 610, connection 605, output device 635, and so forth, to carry out the function.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

Other aspects of this disclosure can include the following clauses:

Clause 1. A system comprising: a case; a U-shaped base structure; a set of wheels configured in the U-shaped base structure, each wheel of the set of wheels being steerable; an elevated structure attached to the U-shaped base structure and having a track; an extension structure configured at least in part with the track on the elevated structure; an engagement structure configured with the elevated structure; and a control system configured to control a motor to control operation of the set of wheels and the extension structure, wherein the system is omnidirectional and enables the extension structure to move up and down the track and retrieve or drop off items at various levels using the engagement structure.

Clause 2. The system of any previous clause, wherein at least one wheel of the set of wheels is driven.

Clause 3. The system of any previous clause, wherein the extension structure configured to be able to move up and down the track and extend and retract.

Clause 4. The system of any previous clause, wherein the extension structure can lower down between extension arms of the U-shaped base structure such that the engagement structure can reach a floor level.

Clause 5. The system of any previous clause, further comprising a reroutable automatic storage and retrieval system.

Clause 6. The system of any previous clause, further comprising at least one sensor that enables data about a surrounding environment of the system to be sensed and utilized for movement of the system.

Clause 7. The system of any previous clause, wherein the extension structure enables double deep capability on a floor level or on a shelf.

Clause 8. The system of any previous clause, wherein the system can utilize drive-in racking or flow racking.

Clause 9. The system of any previous clause, further comprising at least one actuated outrigger for stability.

Clause 10. The system of any previous clause, wherein the extension structure comprises a pantograph mechanism.

Clause 11. The system of any previous clause, further comprising a raised undercarriage enabling an unobstructed view beneath the system.

Clause 12. The system of any previous clause, wherein at least two wheels of the set of wheels is powered.

Clause 13. The system of any previous clause, further comprising a hydraulic circuit for coarse control of the engagement structure.

Clause 14. The system of clause 13 or any previous clause, further comprising a second hydraulic circuit for fine control of the engagement structure.

Clause 15. The system of any previous clause, wherein the control system utilizes x, y and theta velocity commands for movement of the system.

Clause 16. The system of any previous clause, wherein the control system monitors a position of each of the wheels of the set of wheels and automatically halts drive motor commands until the set of wheels are in position.

Clause 17. The system of any previous clause, wherein each wheel of the set of wheels is configured in a corner position of the U-shaped base structure.

Clause 18. The system of any previous clause, wherein a planned path for the system can be changed based on real-time sensor feedback.

Clause 19. The system of any previous clause, wherein a first powered and steerable drive assembly powers a first wheel of the set of wheels and a second powered and steerable drive assembly powers a second wheel of the set of wheels.

Clause 20. The system of any previous clause, wherein a machine learning model is configured with the control system to evaluate data, received by at least one sensor, and adjust movement of the system based on the data.

Clause 21. A method comprising: storing in a non-transitory computer-readable memory a planned path for a robotic system, the robotic system comprising: a case; a U-shaped base structure; a set of wheels configured in the U-shaped base structure, each wheel of the set of wheels being steerable; an elevated structure attached to the U-shaped base structure and having a track; an extension structure configured at least in part with the track on the elevated structure; an engagement structure configured with the elevated structure; and a control system configured to control a motor to control operation of the set of wheels and the extension structure, wherein the robotic system is omnidirectional and enables the extension structure to move up and down the track and retrieve or drop off items at various levels using the engagement structure; retrieving, as managed by the control system, an item via the engagement structure; moving the robotic system according to its planned path to a destination; and dropping off, as managed by the control system, the item at the destination.

What is claimed is:

1. A system comprising:
a case;
a U-shaped base structure connected to the case;
a set of wheels configured in the U-shaped base structure, each wheel of the set of wheels being steerable;
an elevated structure attached to the U-shaped base structure and having a track;
an extension structure configured at least in part with the track on the elevated structure;
an engagement structure configured with the elevated structure; and
a control system configured to control a motor to control operation of the set of wheels and the extension structure, wherein the system is omnidirectional and enables the extension structure to move up and down the track and retrieve or drop off items at various levels using the engagement structure.

2. The system of claim 1, wherein at least one wheel of the set of wheels is driven.

3. The system of claim 1, wherein the extension structure configured to be able to move up and down the track and extend and retract.

4. The system of claim 1, wherein the extension structure can lower down between extension arms of the U-shaped base structure such that the engagement structure can reach a floor level.

5. The system of claim 1, further comprising a reroutable automatic storage and retrieval system.

6. The system of claim 1, further comprising at least one sensor that enables data about a surrounding environment of the system to be sensed and utilized for movement of the system.

7. The system of claim 1, wherein the extension structure enables double deep capability on a floor level or on a shelf.

8. The system of claim 1, wherein the system can utilize drive-in racking or flow racking.

9. The system of claim 1, further comprising at least one actuated outrigger for stability.

10. The system of claim 1, wherein the extension structure comprises a pantograph mechanism.

11. The system of claim 1, further comprising a raised undercarriage enabling an unobstructed view beneath the system.

12. The system of claim 1, wherein at least two wheels of the set of wheels is powered.

13. The system of claim 1, further comprising a hydraulic circuit for coarse control of the engagement structure.

14. The system of claim 13, further comprising a second hydraulic circuit for fine control of the engagement structure.

15. The system of claim 1, wherein the control system utilizes x, y and theta velocity commands for movement of the system.

16. The system of claim 1, wherein the control system monitors a position of each of the wheels of the set of wheels and automatically halts drive motor commands until the set of wheels are in position.

17. The system of claim 1, wherein each wheel of the set of wheels is configured in a corner position of the U-shaped base structure.

18. The system of claim 1, wherein a planned path for the system can be changed based on real-time sensor feedback.

19. The system of claim 1, wherein a first powered and steerable drive assembly powers a first wheel of the set of wheels and a second powered and steerable drive assembly powers a second wheel of the set of wheels.

20. The system of claim 1, wherein a machine learning model is configured with the control system to evaluate data, received by at least one sensor, and adjust movement of the system based on the data.

21. A system comprising:
a base structure;
a set of wheels configured in the base structure, each wheel of the set of wheels being steerable and each wheel configured in a respective corner of the base structure;
an elevated structure attached to the base structure and having a track;
an extension structure configured at least in part with the track on the elevated structure;
an engagement structure configured with the extension structure, wherein the engagement structure can be extended beyond an edge of the base structure for retrieving or dropping off items; and
a control system configured to control a motor to control operation of the set of wheels and the extension structure, wherein the system is omnidirectional and enables the extension structure to move up and down the track and retrieve or drop off items at various levels using the engagement structure.

22. A method comprising:
storing in a non-transitory computer-readable memory a planned path for a robotic system, the robotic system comprising:
a case;
a U-shaped base structure connected to the case;
a set of wheels configured in the U-shaped base structure, each wheel of the set of wheels being steerable;
an elevated structure attached to the U-shaped base structure and having a track;
an extension structure configured at least in part with the track on the elevated structure;
an engagement structure configured with the elevated structure; and
a control system configured to control a motor to control operation of the set of wheels and the extension structure, wherein the robotic system is omnidirectional and enables the extension structure to move up and down the track and retrieve or drop off items at various levels using the engagement structure;
retrieving, as managed by the control system, an item via the engagement structure;
moving the robotic system according to its planned path to a destination; and
dropping off, as managed by the control system, the item at the destination.
